(19) United States
(12) Patent Application Publication
(10) Pub. No.: US 2002/0027666 A1
(43) Pub. Date: Mar. 7, 2002

(54) Printer controller

(76) Inventor: Hidetoshi Ikeda, Dazaifu-shi (JP)

Correspondence Address: PARKHURST & WENDEL, L.L.P., Suite 210, 1421 Prince Street, Alexandria, VA, 22314-2805, US

(21) Appl. No.: 09/939,062

(22) Filed: Aug. 27, 2001

(30) Foreign Application Priority Data
Aug. 28, 2000 (JP) 2000-256929

(51) Int. Cl. G06K 15/02; G06F 3/12; G06F 12/00

(52) U.S. Cl. 358/1.1; 358/1.16; 358/1.15

(57) ABSTRACT

A printer controller for controlling a color printer engine includes an interpreter processor for generating an internal code in band unit from print data being input as a page description language (PDL), a rasterizing processor for developing the internal code into raster data in band unit, a band management processor for managing the raster data in band unit, and a raster data transmitter for transmitting the data in the sequence on the basis of management information from the band management processor. Since the raster data can be managed in band unit, continuity of memory addresses between bands is not necessary, so that the printing time can be shortened.

### FIELD OF THE INVENTION

The present invention relates to a printer controller for controlling a color printer engine.

### BACKGROUND OF THE INVENTION

A full-color printer employing an electro-photographic process or ink jet becomes a mainstream of office printers as an output terminal of a personal computer or work station. To print documents with such full-color printer, a printer controller for converting a document prepared with the personal computer or work station into data that can be printed with the printer engine is required.

FIG. 10 shows a printing system having a conventional printer controller. FIG. 11 is a block diagram showing the conventional printer controller.

The printing system includes a host computer 1 for converting the document to be printed into a page description language (PDL), a color printer engine 7 for color-printing the document, and a printer controller 2 for converting the PDL into data that can be printed with the color printer engine 7. The controller 2 includes an interface 3 for communicating with the host computer 1 and the color printer engine 7, a central processing unit (CPU) 4 for controlling the entire printer controller 2, a ROM 5, a RAM 6, a PDL data receiver 8 for receiving PDL data, an interpreter processor 9 for converting the PDL data into a band-unit display list (DL) which is an internal code generated in band unit, a rasterizing processor 10 for converting the band-unit DL into raster data, and a raster data transmitter 11 for transmitting the raster data. The RAM 6 includes a receiving buffer region 12, a band-unit DL storing region 13, and a raster data storing region 14. The band is the unit that can be processed at once by the system, and may coincide with one page.

An operation of the printing system and printer controller 2 having such configuration will be explained below by referring to FIG. 10 and FIG. 11.

In FIG. 10, the host computer 1 converts the document to be printed into the PDL, examines whether the printer controller 2 is ready to receive data through the interface 3 or not, and transmits the PDL data to the printer controller 2. The printer controller 2 converts the received PDL data into raster data, and sends it to the color printer engine 7 for printing the document.

In FIG. 11, the PDL data transferred to the printer controller 2 is received by the PDL data receiver 8, and the PDL data receiver 8 stores the received PDL data once in the receiving buffer region 12 in the RAM 6. The interpreter processor 9 converts the PDL data in the receiving buffer region 12 into the band-unit DL so as to have the data interpreted easily by the subsequent rasterizing processor 10, and generates the band-unit DL for at least one page in the band-unit DL storing region 13. Then, the rasterizing processor 10 reads out the band-unit DL from the band-unit DL storing region 13, rasterizes it in band unit to generate raster data, and stores the raster data in the raster data storing region 14. When raster data for one page is generated, the raster data transmitter 11 reads out the raster data from the raster data storing region 14, and sends it to the color printer engine 7 for printing the data.

The color printer engine 7 employing an electrophotographic technology includes an N-pass color printer engine for forming an image of one color each to form images by color toners of N colors, and a tandem color printer engine for simultaneously forming images of all colors. Printing by the tandem color printer engine will be explained below.

FIG. 12 shows a tandem color printer engine 7 for forming images by four color toners. The engine 7 includes a K-color (black) developer 30, a C-color (cyan) developer 31, an M-color (magenta) developer 32, a Y-color (yellow) developer 33, a K-color photosensitive material 34, a C-color photosensitive material 35, an M-color photosensitive material 36, a Y-color Y photosensitive material 37, an intermediate transferring element 38, a printing paper 39, and a fixer 40.

The developers 30 to 33 and photosensitive materials 34 to 37 develop printed images simultaneously, and the photosensitive materials 34 to 37 transfer the images on the intermediate transferring element 38, and overlay the four color images. The images are then transferred to the printing paper 39 by the intermediate transferring element 38, and the fixer 40 fixes toners on the printing paper 39. As shown in FIG. 12, the developers 30 to 33 and photosensitive materials 34 to 37 of individual colors are arranged at a specific distance, for printing documents. Therefore, the images are actually formed as being shifted in position in a printing direction sequentially from the K-color, followed by the C-color, M-color, and Y-color, though the images are printed “simultaneously”.

An operation of the printer controller 2 corresponding to such tandem color printer engine 7 will be explained by referring to FIG. 13 to FIG. 15. FIG. 13 is a time chart showing an interpreter processing and rasterizing processing of the printer controller 2. FIG. 14A to FIG. 14E show data in the raster data storing region 14 at times t1 to t5, respectively. FIG. 15 shows the rasterizing processing for a second page. FIG. 13 shows a time chart of the interpreter processing in the top, that of the rasterizing processing in the middle, and that of an raster data transmission in the bottom for printing a two-page document.

In FIG. 13, when the interpreter processing for the first page is over, a band-unit DL for the page is generated. The band-unit DL for the first page is put into the rasterizing processing simultaneously for the C-color, M-color, Y-color, and K-color in this order. In the interpreter processing, a band-unit DL for the second page is generated simultaneously. When the rasterizing processing of the first page is over, the raster data transmitter 11 transmits the raster data of the first page to the color printer engine 7. At the moment, as explained above, in order to overlay four colors by the tandem printer engine, data is issued by shifting in time slightly in the sequence of the K-color, C-color, M-color, and Y-color.

FIG. 14A to FIG. 14E show the raster data storing region 14 at the time t1, t2, t3, t4, and t5 in FIG. 13, respectively. At the time t1, the rasterizing processing for the first page is over. In FIG. 14, K-1, C-1, . . . indicate the first page of the K-color, first page of the C-color, and so forth. At the time t2, raster data of the K-color of the first page starts to be transmitted, and then, an output portion of the data K-1 is not needed. In the unnecessary data portion, the rasterizing processing of the K-color for the second page can be executed. The rasterizing processing of the K-color for the second page is indicated as K-2. At the time t3, C-color raster data starts to be output, and the rasterizing processing for the K-color of the second page (K-2) and the rasterizing processing for the C-color of the second page (C-2) are executed. At the time t4, M-color raster data starts to be output, and at the time t5, final Y-color raster data starts to be output. Therefore, the rasterizing processing of the M-color and Y-color (M-2, Y-2) are started sequentially.

Similarly, when the rasterizing processing for the second page is over, raster data of the second page starts to be transmitted, and images of the second page are printed. That is, raster data cannot be transmitted unless rasterizing processing is over.

In the document having a word “TEST” in the first band of the document of the second page as shown in FIG. 15, a band-unit DL for drawing it in all colors is formed. At the time t1, the band-unit DL expressing “TEST” is read, and the rasterizing processing of the K-color is executed. Then, at the time t2, t3, and t4, the same band-unit DL is read, and rasterizing processing of the C-color, M-color, and Y-color is executed. Therefore, since the same band-unit DL is read four times to execute the rasterizing processing, the processing speed of the printer controller 2 drops in accordance with an increase of the size of the band-unit DL.

### SUMMARY OF THE INVENTION

A printer controller having a high processing speed by reading the same band-unit display list (DL) only once for controlling the color printer engine is presented. The printer controller includes an interpreter processor for generating an internal code in band unit from print data in a page description language, a rasterizing processor for developing the internal code generated in band unit into raster data in band unit, a band management processor for managing the developed raster data in band unit, and a raster data transmitter for controlling the output sequence of data on the basis of the management information from the band management processor.

### BRIEF DESCRIPTION OF THE DRAWINGS

FIG. 1 shows a printing system incorporating a printer controller according to embodiment 1 of the present invention.

FIG. 2 is a block diagram of the printer controller.

FIG. 3 shows an operation of the printer controller corresponding to a tandem color printer engine.

FIG. 4A and FIG. 4B show data in a raster data storing region of the printer controller.

FIG. 5 shows a comparison between a processing by the printer controller according to embodiment 1 and that by a conventional printer controller.

FIG. 6 is a block diagram of a printer controller according to embodiment 2 of the invention.

FIG. 7 shows data in a raster data storing region at a time t3 in FIG. 3.

FIG. 8 is a block diagram of a printer controller according to embodiment 3 of the invention.

FIG. 9A to FIG. 9C show data in raster data storing region of the printer controller in embodiment 3.

FIG. 10 shows a printing system incorporating a conventional printer controller.

FIG. 11 is a block diagram of the conventional printer controller.

FIG. 12 shows a tandem color printer engine.

FIG. 13 shows an interpreter processing and rasterizing processing of the conventional printer controller.

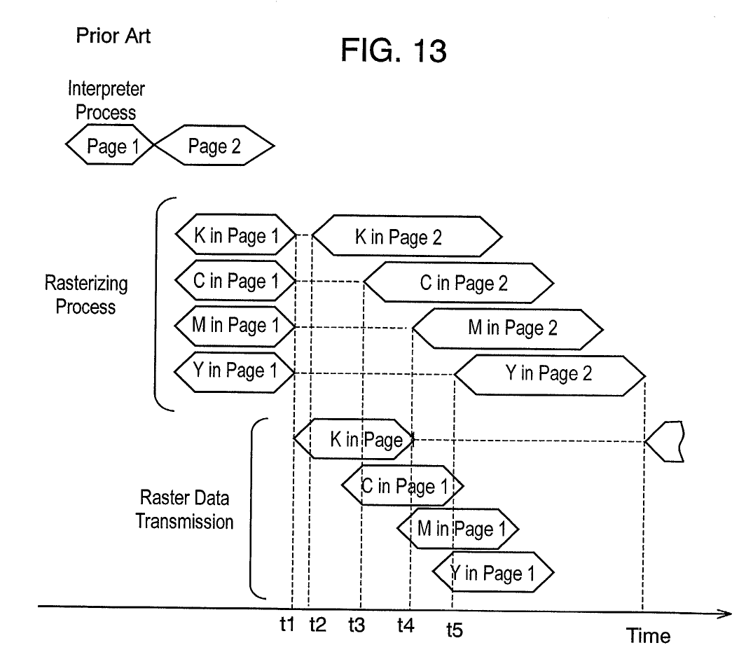

FIG. 14A to FIG. 14E show data in a raster data storing region of the conventional printer controller.

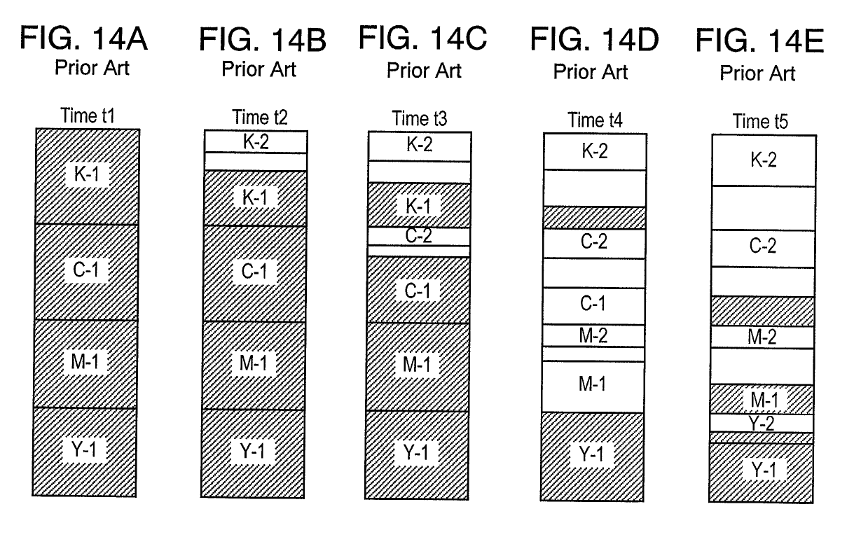

FIG. 15 shows a rasterizing processing for a second page of the conventional printer controller.

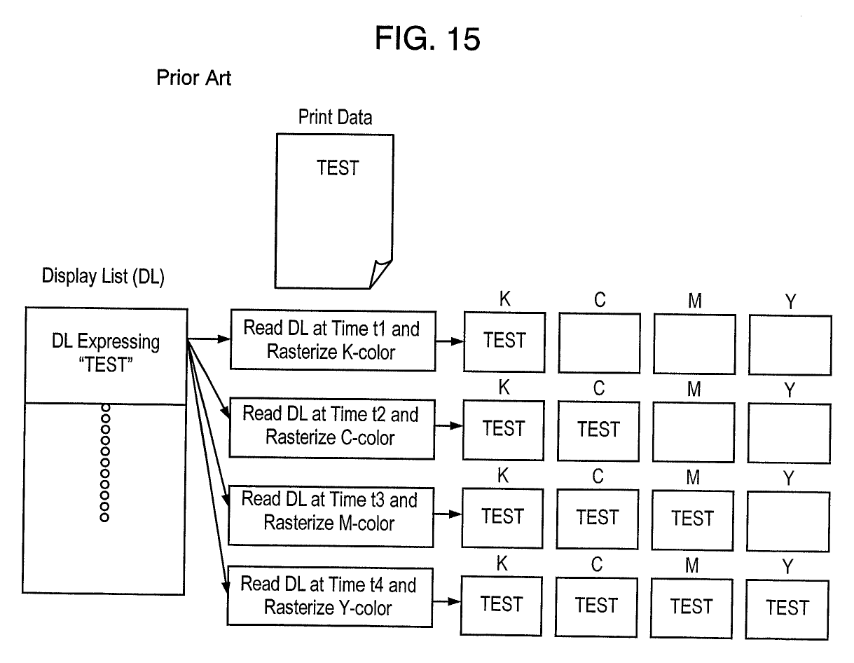

### DESCRIPTION OF THE PREFERRED EMBODIMENTS

### Embodiment 1

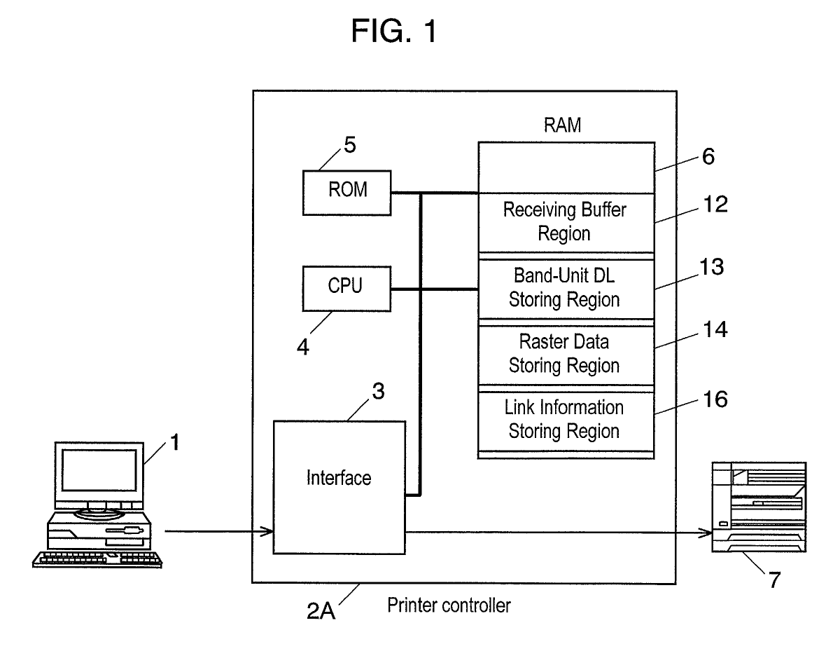

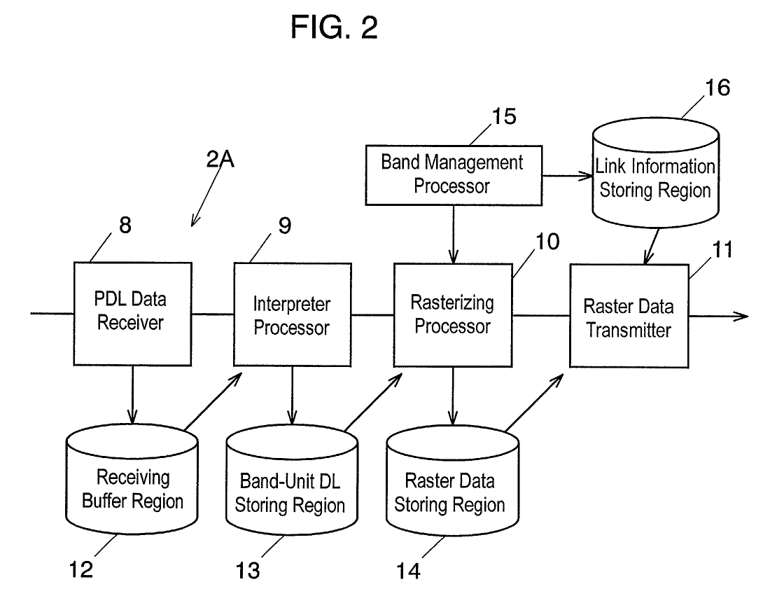

FIG. 1 shows a printing system incorporating a printer controller according to embodiment 1 of the present invention. FIG. 2 is a block diagram of the printer controller.

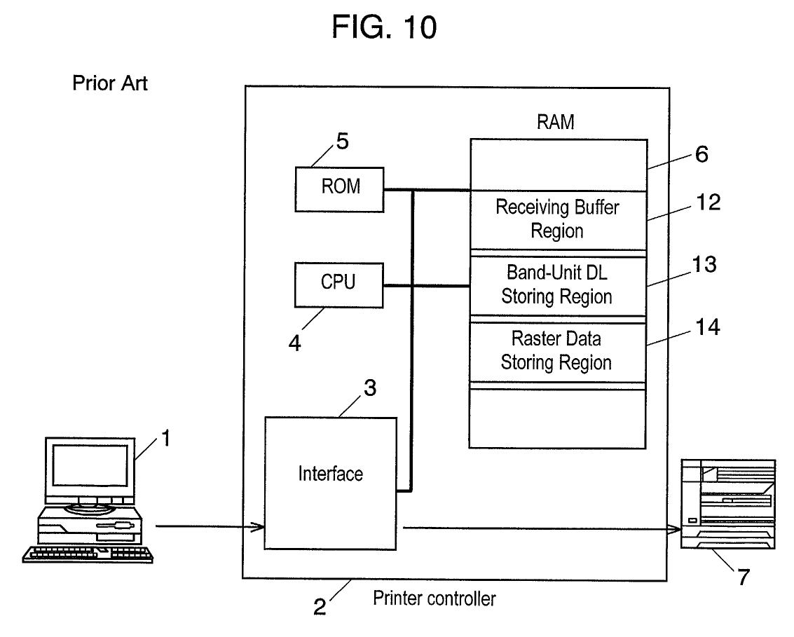

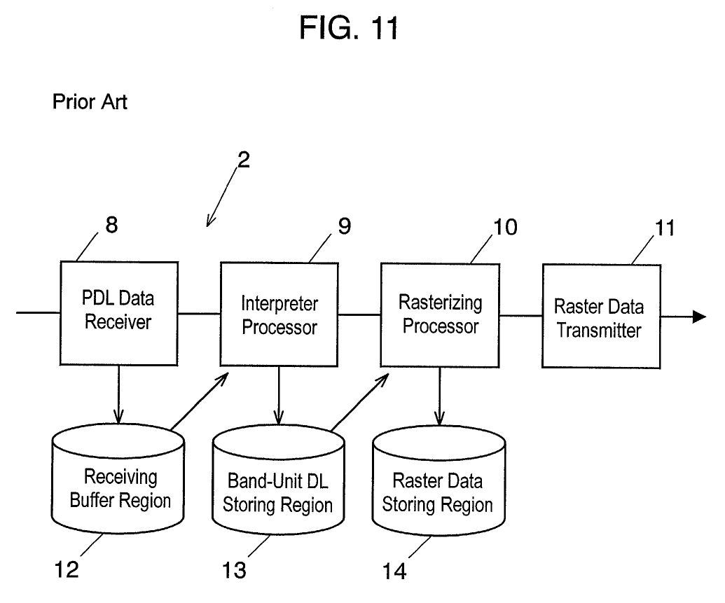

The printing system includes a host computer 1, a color printer engine 7, and a printer controller 2A for converting a printer description language (PDL) into data that can be printed by the color printer engine 7. The controller 2A includes an interface 3, a CPU 4, a ROM 5, a RAM 6, a color printer engine 7, a PDL data receiver 8, an interpreter processor 9, a rasterizing processor 10, a raster data transmitter 11, a receiving buffer region 12, a band-unit display list (DL) storing region 13, and a raster data storing region 14. They are the same as those in FIG. 10 and FIG. 11, and are hence denoted by the same reference numerals and are not specifically described herein. The controller 2A further includes a band management processor 15 for managing the raster data in band unit, and a link information storing region 16 for storing link information indicating a link between bands.

An operation of the printing system and printer controller 2A will be explained by referring to FIG. 1 and FIG. 2.

Similarly to the conventional controller, the host computer 1 converts a document to be printed into PDL data, examines whether the printer controller 2A is ready for receiving data through the interface 3, and transmits the PDL data to the printer controller 2A. The printer controller 2A converts the received PDL data into raster data, and sends it to the color printer engine 7 for printing the document.

In FIG. 2, the PDL data transferred to the printer controller 2A is received with the PDL data receiver 8, and the PDL data receiver 8 stores the PDL data temporarily in the receiving buffer region 12 in the RAM 6. The interpreter processor 9 converts the PDL data in the receiving buffer region 12 into a band-unit DL so as to interpret it easily in the subsequent rasterizing processor 10. The processor 9 generates the band-unit DL for at least one page in the band-unit DL storing region 13. Then, the rasterizing processor 10 reads out the band-unit DL from the band-unit DL storing region 13, rasterizes it in band unit, and stores the raster data in the raster data storing region 14. At this moment, the band management processor 15 manages the raster data in band unit, and stores link information indicating a link between bands in the link information storing region 16. When the raster data of one page is generated, the raster data transmitter 11 reads out the raster data from the raster data storing region 14 according to the sequence in the link information, and sends the data to the color printer engine 7 for printing the data.

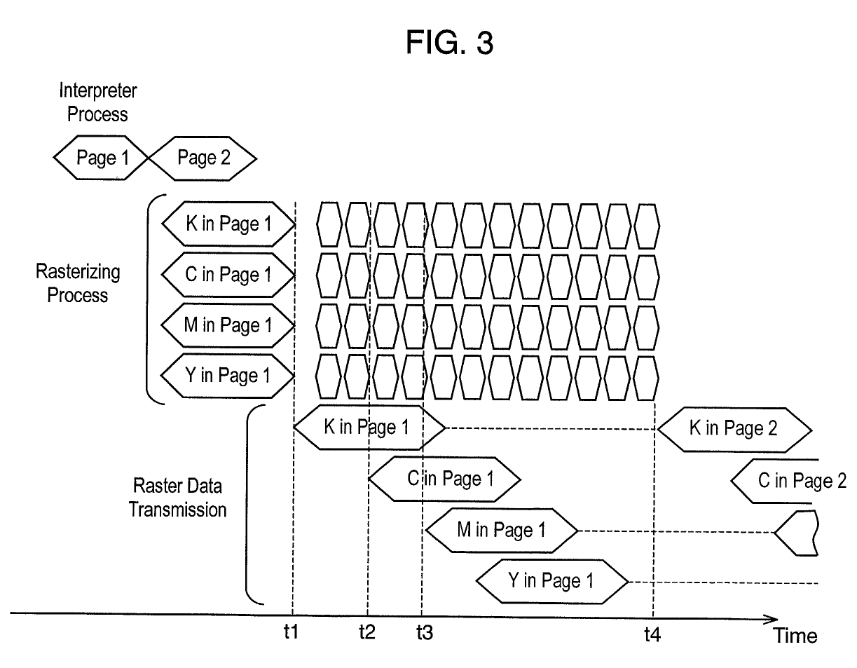

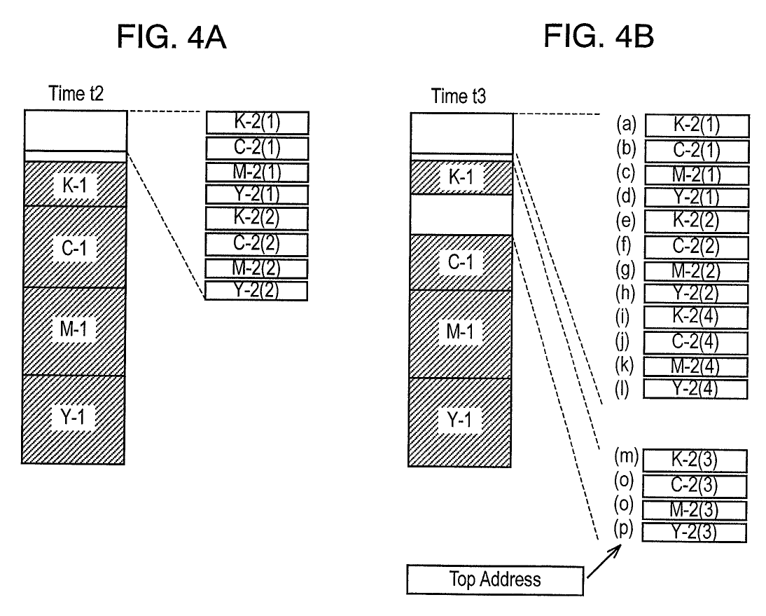

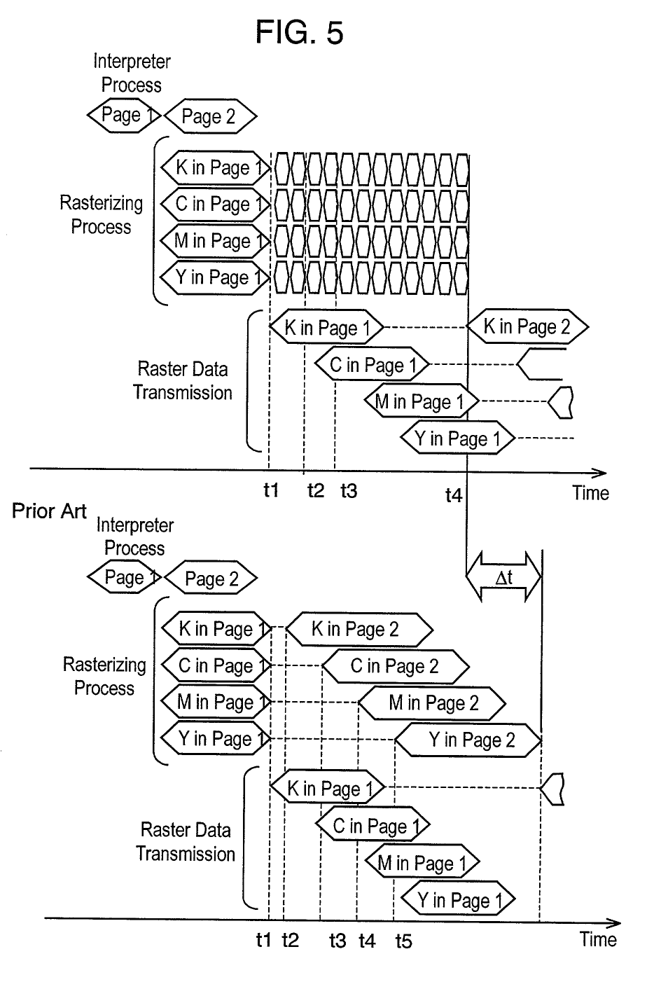

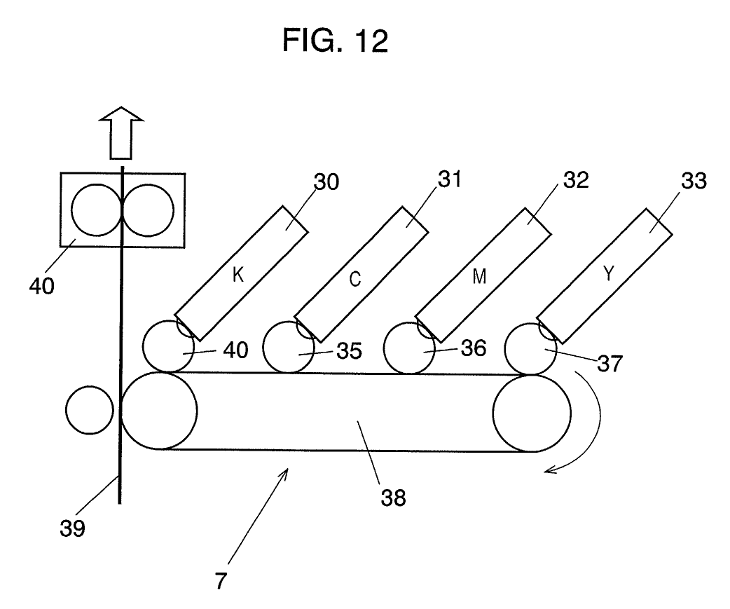

An operation of the printer controller 2A corresponding to the tandem color printer engine 7 shown in FIG. 12 will be explained by referring to FIG. 3 to FIG. 5. FIG. 3 shows an operation of the printer controller 2A corresponding to the tandem color printer engine 7. FIG. 4A and FIG. 4B show data in the raster data storing region 14 at a time t2 and t3, respectively. FIG. 5 shows a comparison between a processing time by the controller in the embodiment and a processing time by a conventional controller. FIG. 3 shows the time chart of the interpreter processing in the top, that of the rasterizing processing in the middle, and that of the raster data transmission in the bottom for printing a two-page document.

In FIG. 3, when the interpreter processing of the image of the first page is over, a band-unit DL of one page is generated. On the basis of the band-unit DL, the rasterizing processing is executed simultaneously for four colors on a image on the first page. In the interpreter processing, a band-unit DL of the second page is generated simultaneously. When the rasterizing processing for the first page is over, the raster data transmitter 11 transmits the raster data of the first page to the color printer engine 7. At this moment, as explained in the prior art, data shifted slightly in the sequence of the K-color, C-color, M-color, and Y-color is issued.

FIG. 4A and FIG. 4B show data in the raster data storing region 14 at a time t2 and t3 in FIG. 3, respectively. At the time t1, the data is the same as that in the conventional controller, and hence is not shown in FIG. 4. At the time t2, raster data of the K-color of the first page starts to be transmitted. An output portion of the data K-1 is not needed. Then, in the portion, the rasterizing processing for the K-color of the second page can be executed. In the conventional controller, raster data of the K-color of the second page is stored in a vacant region after the raster data of the K-color of the first page is transmitted. According to this embodiment, data of all colors is stored in band unit. As shown in the magnified view in FIG. 4A, all color data are rasterized in band unit, that is, the K-color of the first band of the second page, (expressed as “K-2(1)”), the C-color of the first band of the second page (“C-2(1)”), the M-color of the first band of the second page (“M-2(1)”), the Y-color of the first band of the second page (“Y-2(1)”), and so forth. Then, the data is stored in the raster data storing region 14. At the time t3, C-color raster data starts to be output. As shown in a enlarged view in FIG. 4B, raster data of the second page is stored in band unit. In the enlarged view in FIG. 4B, data (a), (b), . . . , (p) indicate the top addresses of raster data storing areas. With the data, the band management processor 15 generates link information, for example, “(a)→(e)→(m)→(i) . . . ” for the K-color of the second page, and stores the information in the link information storing region 16. At the time t4, the rasterizing processing for an image of the second page is over, and then, the raster data starts to be transmitted. At this moment, the data is issued in the sequence according to the link information of the band-unit raster data of the second page previously stored in the link information storing region 16.

By the processing, raster data is managed in band unit. Particularly in the rasterizing processing after the second page, the internal code of one band (a band-unit DL) is read out only once, and then, all colors of the band are rasterized. Therefore, as shown in FIG. 5, the processing time is shortened by At as compared with that of the conventional controller.

In the explanation in FIG. 4, a generation of link information of the first page is not mentioned. To unify the processing, link information may be also generated for the first page. In this embodiment, a control of the tandem color printer engine 7 is explained, but it may be similarly applied to a control for the N-pass color printer engine or ink jet type engine.

According to the embodiment, as explained herein, since the raster data after the rasterizing processing can be managed in band unit, a continuity of a memory address of the next band is not necessary. Particularly in the rasterizing processing after the second page, the internal code of one band (a band-unit DL) is read out only once, and all colors of the band are rasterized, so that the printing time can be shortened.

### Embodiment 2

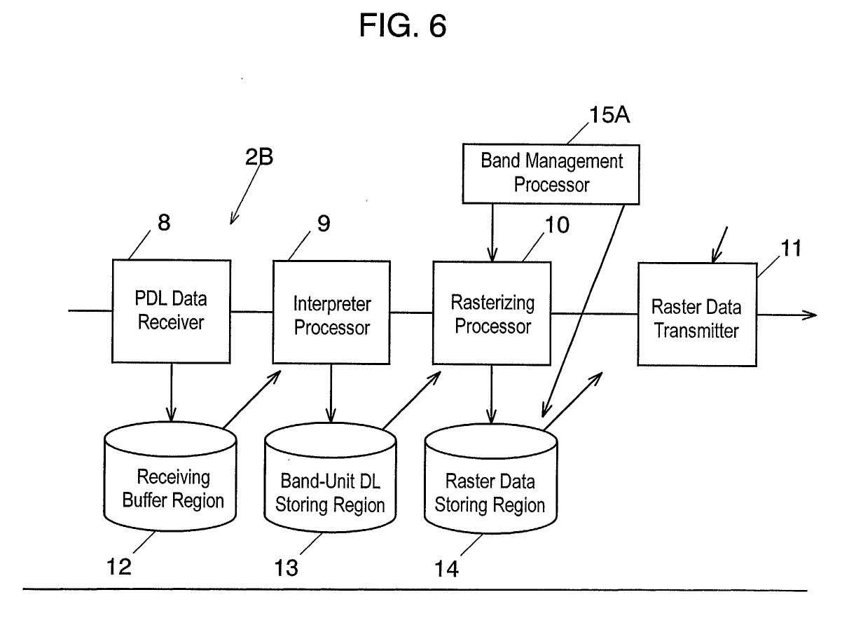

FIG. 6 is a block diagram of a printer controller according to embodiment 2 of the invention.

In FIG. 6, a PDL data receiver 8, an interpreter processor 9, a rasterizing processor 10, a raster data transmitter 11, a receiving buffer region 12, a band-unit DL storing region 13, and a raster data storing region 14 are the same as in FIG. 2, and are hence denoted by the same reference numerals and are not specifically described herein. The printer controller 2B further includes a band management processor 15A for managing raster data in band unit. An outline of an operation of the controller is the same as in embodiment 1, and the explanation of the outline is omitted.

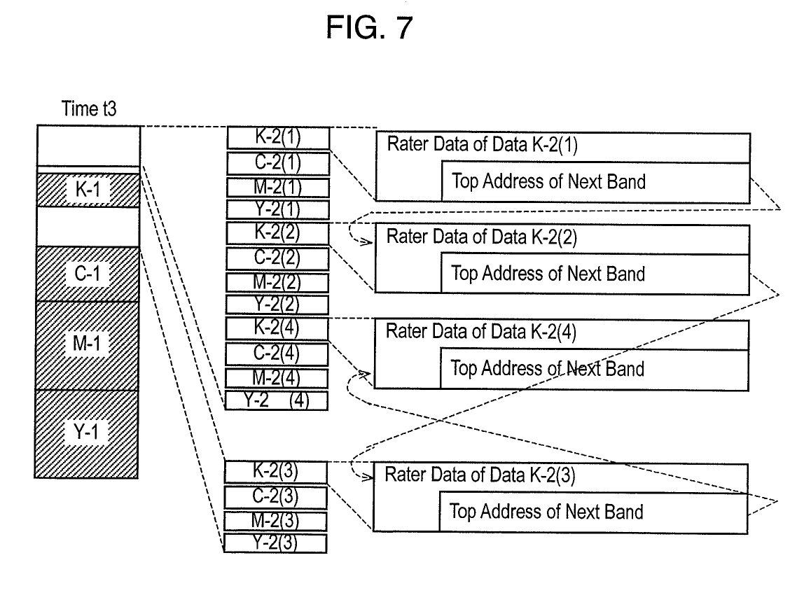

An operation of the printer controller 2B having such configuration will be explained by referring to FIG. 7. FIG. 7 shows data in the raster data storing region 14 at time t3 in FIG. 3.

In FIG. 6, the PDL data transferred to the printer controller 2B is received in the PDL data receiver 8, and is stored in the receiving buffer region 12 in the RAM 6. The interpreter processor 9 converts the PDL data in the receiving buffer region 12 into the band-unit DL for easily interpreting it in the rasterizing processor 10. The processor 9 generates the band-unit DL of at least one page in the band-unit DL storing region 13. Then, the rasterizing processor 10 reads out the band-unit DL from the band-unit DL storing region 13, rasterizes it to obtain raster data, and stores the raster data in the raster data storing region 14. A time chart of these processing steps is the same as that in embodiment 1, and the explanation is omitted. Instead of storing the link information “(a)→(e)→(m)→(i) . . . ” in the link information management region 16 in FIG. 4B explained in embodiment 1, the band management processor 15 attaches a top address of data K-2(2) to the end of data K-2(1), attaches a top address of data K-2(3) to the end of the data K-2(2), and attaches a top address of data K-2(4) to the end of the data K-2(3).

When raster data of one page is generated, the raster data transmitter 11 reads out the raster data from the raster data storing region 14, and transmits the data to the color printer engine 7 to print it. At this moment, the data divided in band unit is read out according to top address of the next band attached at the end of the preceding raster data.

By the processing, link information of raster data is obtained in band unit. Particularly in the rasterizing after the second page, the internal code of one band (a band-unit DL) is read out only once, and all colors are rasterized for the DL of the band. Therefore, as shown in FIG. 5, the processing time is shortened by Δt as compared with that of the prior art.

Meanwhile, instead of recording the information showing the link of data to the next band at the end of raster data, the information may be stored at a predetermined specific position, for example, at the beginning of the raster data. In the embodiment, controlling the tandem color printer engine 7 is explained, but the N-pass color printer engine or ink jet type engine can be similarly controlled.

According to the embodiment, as explained herein, since the raster data after rasterizing processing can be managed in band unit, continuity of a memory address for the next band is not necessary. Particularly in the rasterizing after the second page, the DL of one band is read out only once, and all colors in the DL of the band are rasterized, so that the printing time can be shortened.

### Embodiment 3

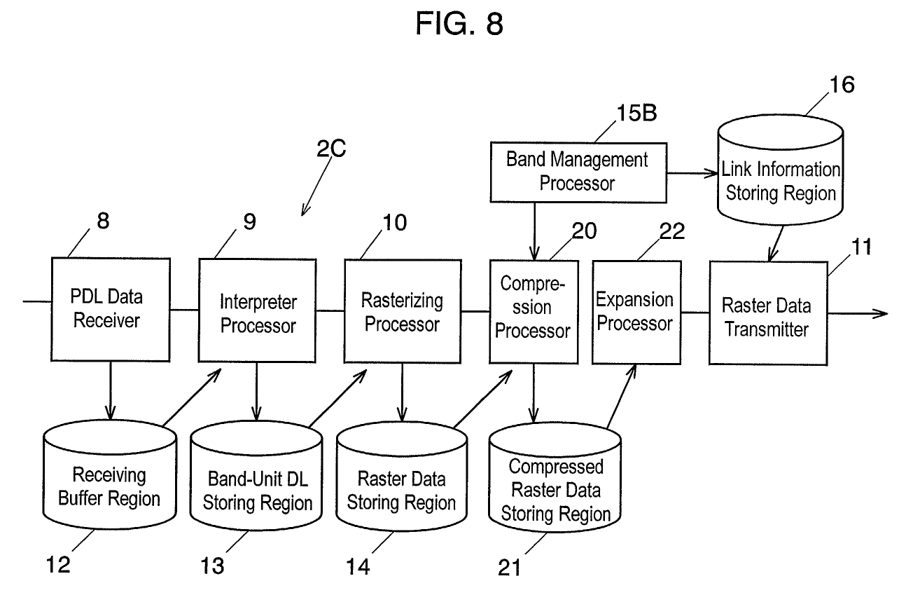

FIG. 8 is a block diagram of a printer controller according to embodiment 3 of the invention.

In FIG. 8, a printer description language (PDL) data receiver 8, an interpreter processor 9, a rasterizing processor 10, a raster data transmitter 11, a receiving buffer region 12, a band-unit display list (DL) storing region 13, a raster data storing region 14, and a link information storing region 16 are the same as those shown in FIG. 2, are hence denoted by the same reference numerals, and are not specifically described herein. The printer controller 2C further includes a band management processor 15B for managing raster data in band unit, a compression processor 20 for compressing the raster data, a compressed raster data storing region 21 for storing the compressed raster data, and an expansion processor 22 for expanding the compressed raster data. An outline of an operation of the controller is the same as in embodiment 1, and an explanation of the outline is omitted.

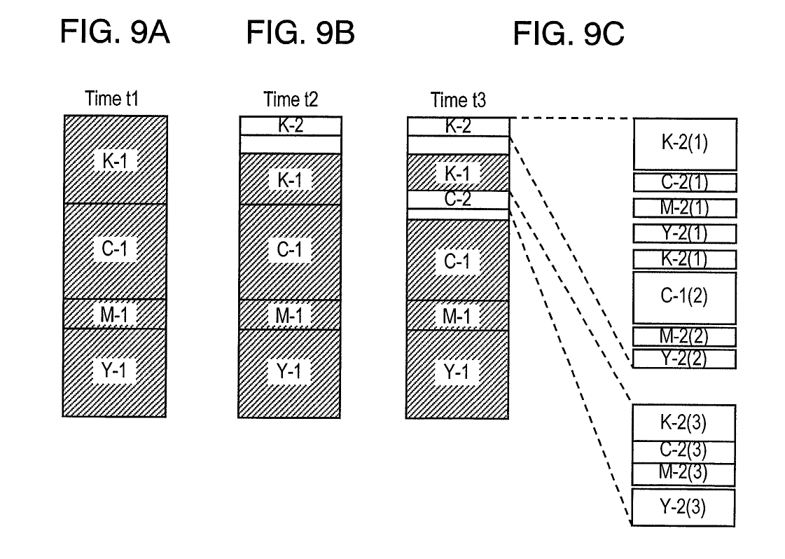

An operation of the printer controller 2C having such configuration will be explained by referring to FIG. 9. FIG. 9A, FIG. 9B, and FIG. 9C show data in the raster data storing region 14 at time t1, t2, and t3 in FIG. 3, respectively.

In FIG. 8, PDL data transferred to the printer controller 2C is received in the PDL data receiver 8, and is stored in the receiving buffer region 12 in the RAM 6. The interpreter processor 9 converts the PDL data in the receiving buffer region 12 into a band-unit DL to interpret it easily in the rasterizing processor 10. The processor 9 generates a band-unit DL of at least one page in the band-unit DL storing region 13. Then, the rasterizing processor 10 reads out the band-unit DL from the band-unit DL storing region 13, rasterizes the DL in band unit to obtain raster data, and stores the raster data in the raster data storing region 14. At this moment, the band management processor 15B manages the raster data in band unit, and stores link information showing a link between bands in the link information storing region 16. When raster data of one band is generated, the compression processor 20 compresses the raster data according to a specified compressing method, and stores the compressed raster data in the compressed raster data storing region 21. After rasterizing and compressing data of one page, the expansion processor 22 expands the compressed raster data in band unit according to the sequence in link information, and restores the raster data. The restored raster data is transmitted to the color printer engine 7 by the raster data transmitter 11, and is printed by the color printer engine 7.

The compressing method in the compression processor 20 includes, for example, JBIG and JPEG, and all still picture compressing techniques can be applied in the embodiment.

By the processing, the link information of raster data is obtained in band unit. Particularly in the rasterizing after the second page, an internal code of one band (a band-unit DL) is read out only once, and all colors in the DL of the band are rasterized. Therefore, as shown in FIG. 5, the processing time is shortened by Δt as compared with that of the prior art. Further, since the raster data is compressed, the required memory size is smaller, and an inexpensive printer controller can be presented.

In the embodiment, the compressing and expanding process is combined in the controller in embodiment 1, but it may be also combined in the controller in embodiment 2. In this case, the raster data may be compressed either before or after the link address is attached. In the embodiment, moreover, controlling the tandem color printer engine 7 is explained, but the N-pass color printer engine or ink jet type engine may be similarly controlled.

According to the embodiment, as explained herein, since the raster data after the rasterizing processing can be managed in band unit, continuity of memory addresses of the next band is not necessary. Particularly in rasterizing after the second page, the DL of one band is read out only once, and all colors in the DL of the band are rasterized. Therefore, the printing time can be shortened. Further, since the data is compressed, the capacity of a memory for storing the raster data after the rasterizing processing may be smaller, so that the controller can be presented at a lower cost.

What is claimed is:

1. A printer controller for controlling a color printer engine, comprising:
interpreter processing means for generating an internal code in band unit from print data;
rasterizing processing means for developing the internal code into raster data in band unit;
raster data storing means for storing the raster data;
band management processing means for managing the stored raster data in band unit; and
raster data transmitting means for outputting the stored raster data in a sequence based on management information from the band management processing means.

2. The printer controller of claim 1, further comprising compression processing means for compressing, in band unit, the raster data developed by the rasterizing processing means, wherein said raster data storing means stores the compressed raster data.

3. The printer controller of claim 1,
wherein said band management processing means manages the stored raster data in band unit and attaches a top address of raster data of a next band of a specific band to the raster data of the specific band as a link address, and
wherein said raster data transmitting means outputs the stored raster data in a sequence based on the link address.

4. The printer controller of claim 3, further comprising compression processing means for compressing, in band unit, the raster data developed by the rasterizing processing means, wherein said raster data storing means stores the compressed raster data.

5. The printer controller of claim 3, further comprising compression processing means for compressing, in band unit, the raster data to which the top address is attached, wherein said raster data storing means stores the compressed raster data.
